(19) United States
(12) Patent Application Publication
(10) Pub. No.: US 2009/0320064 A1
(43) Pub. Date: Dec. 24, 2009

(54) Triggers for Media Content Firing Other Triggers

(75) Inventors: Eric R. Soldan, Saratoga, CA (US); Bradley R. Pettit, Los Gatos, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/244,451

(22) Filed: Oct. 2, 2008

Related U.S. Application Data
(63) Continuation-in-part of application No. 12/141,924, filed on Jun. 19, 2008.

(51) Int. Cl. H04N 7/025

(52) U.S. Cl. 725/34

(57) ABSTRACT

In accordance with one or more aspects of the triggers for media content firing other triggers, a check is made as to whether a presentation of media content satisfies a criteria portion of a trigger. When the presentation satisfies the criteria portion, one or more actions in a payload portion of a different trigger are performed.

### RELATED APPLICATIONS

This application is a continuation-in-part of U.S. patent application Ser. No. 12/141,924, filed Jun. 19, 2008, which is hereby incorporated by reference herein.

### BACKGROUND

As computing devices and television viewing have begun to merge, enhanced functionality can be made available to television viewers. Unfortunately, a relatively tight coupling between the particular functionality to be provided and the television program during which the functionality is to be provided is typically required. This can be problematic because it makes authoring and deploying such programs and enhanced functionality more difficult.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects of the triggers for media content firing other triggers, for a first trigger of multiple triggers a check is made as to whether a presentation of media content satisfies a criteria portion of the first trigger. When the presentation satisfies the criteria portion, one or more actions in a payload portion of a second trigger of the multiple triggers are performed.

In accordance with one or more aspects of the triggers for media content firing other triggers, a first trigger including both a criteria portion and a payload portion is accessed. The criteria portion identifies one or more criteria, and the payload portion identifies a second trigger. Data corresponding to media content being presented is accessed, and a check is made as to whether the data satisfies the one or more criteria. One or more actions identified in a payload portion of the second trigger are performed in response to the data satisfying the one or more criteria.

In accordance with one or more aspects of the triggers for media content firing other triggers, a device includes a trigger store and a monitor module. The trigger store stores multiple triggers, each including a criteria portion and a payload portion. The criteria portion identifies one or more criteria and the payload portion identifies one or more other triggers. The monitor module monitors data corresponding to media content being presented, to detect when the data satisfies the one or more criteria of one of the multiple triggers, and to perform one or more actions identified in the one or more other triggers identified by the one trigger when the data satisfies the one or more criteria.

### BRIEF DESCRIPTION OF THE DRAWINGS

The same numbers are used throughout the drawings to reference like features.

FIG. 1 illustrates an example consumer device implementing the triggers for media content firing other triggers in accordance with one or more embodiments.

FIG. 2 illustrates an example trigger that can be used with the triggers for media content firing other triggers content in accordance with one or more embodiments.

FIG. 3 is a flowchart illustrating an example process for triggers for media content firing other triggers in accordance with one or more embodiments.

FIG. 4 illustrates an example system in which one or more embodiments of triggers for media content firing other triggers can be implemented.

FIG. 5 illustrates various components of an example consumer device that can implement one or more embodiments of triggers for media content firing other triggers.

FIG. 6 illustrates an example entertainment and information system in which one or more embodiments of triggers for media content firing other triggers can be implemented.

### DETAILED DESCRIPTION

Triggers for media content firing other triggers is discussed herein. A trigger for use with media content includes both a criteria portion and a payload portion. The criteria portion includes one or more criteria that are to be satisfied. When the one or more criteria are satisfied, one or more actions included in the payload portion are performed. These one or more actions include performing one or more actions of another trigger regardless of whether the one or more criteria in the criteria portion of the other trigger are satisfied.

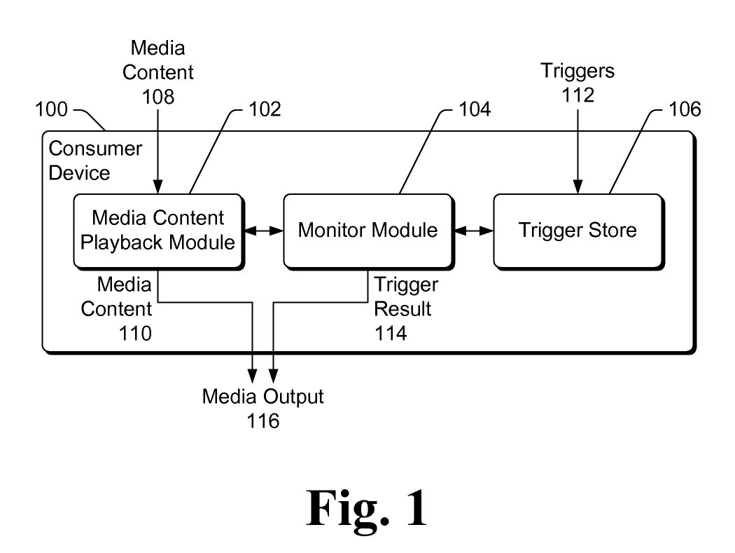

FIG. 1 illustrates an example consumer device 100 implementing the triggers for media content firing other triggers in accordance with one or more embodiments. Consumer device 100 can be any of a variety of devices that output video for display. For example, consumer device 100 can be a computer, such as a desktop computer, server computer, a mobile station, an entertainment appliance, a set-top box communicatively coupled to a display device, a video playback device (e.g., digital video recorder (DVR), digital versatile disk (DVD) player, etc.), a television, a cell or other wireless phone, a game console, an automotive PC, and so forth. Thus, consumer device 100 can range from full resource devices with substantial memory and processor resources (e.g., personal computers, game consoles, etc.) to a low-resource device with limited memory and/or processing resources (e.g., traditional set-top boxes, hand-held game consoles, DVD players, etc.).

Consumer device 100 includes a media content playback module 102, a monitor module 104, and a trigger store 106. Media content refers to one or more of a variety of different types of content that can be played back to a user. Oftentimes media content is audio/video content (e.g., particular programs such as movies, sitcoms, commercials, news broadcasts, documentaries, sporting events, and so forth). Alternatively, media content can be only one type of content (e.g., just audio content, just video content, etc.), or can be other types of content (e.g., images, text, and so forth).

Media content playback module 102 receives media content 108 and outputs media content 110. Media content playback module 102 converts media content 108 into a format that can be played back (e.g., displayed by a display device, played back by speakers, etc.) and outputs the converted media content as media content 110. Media content playback module 102 can also receive input from a user (e.g., via a remote control device) or other component or module of device 100 to control the output of media content 110, such as to pause playback of the content, select particular media content for playback, fast forward or rewind through the media content, and so forth.

Media content 110, along with trigger result 114 as discussed in more detail below, are output by consumer device 100 as media output 116. In one or more embodiments, consumer device 100 plays back media output 116 (e.g., displays video content, plays back audio content, and so forth). In other embodiments consumer device 100 generates one or more signals based on media content 108 and/or trigger result 114 that is output to one or more other devices (e.g., televisions, projectors, speakers, etc.) which in turn present media output 116.

Media content 108 can be received from a variety of different sources. These sources can be local sources, such as a hard disk or an optical disc (e.g., a DVD) that is inserted into, coupled to, or included as part of consumer device 100. These sources can also be remote sources, such as one or more remote servers or other devices making content 108 available to consumer device 100. Remote sources can make content 108 available over a variety of different types of networks, such as one or more of the Internet, a wide area network (WAN), a local area network (LAN), a wireless network, a telephone network, an intranet, and so forth.

In one or more embodiments media content 108 also includes metadata. The metadata can be included as part of (e.g., embedded in) other types of content (e.g., included in a vertical blanking interval (VBI) of video content, included in a packet header, and so forth). Alternatively, this metadata can be separate from other types of content, such as being included in a separate stream or channel from the audio, video, and/or other types of content. This metadata included in media content 108 is associated with, and describes, the audio, video, and/or other types of content in media content 108. Examples of such metadata include closed captioning data that is a text version of the audio content included in media content 108, teletext data corresponding to media content 108, song or program title information corresponding to media content 108, and so forth.

Trigger store 106 receives and stores triggers 112. Triggers 112 can be received from a variety of different sources. Analogous to media content 108, these sources can be local sources or remote sources making triggers 112 available over a variety of different types of networks. By way of example, triggers 112 can be received with media content (e.g., embedded therein, as part of a separate stream, in metadata of the media content, etc.), can be received with programming guide data, can be received via a separate communication with a trigger source, and so forth.

Each trigger 112 includes a payload portion identifying one or more actions to be performed, and a criteria portion identifying one or more criteria that are to be satisfied in order for the one or more actions in the payload portion to be performed. Trigger store 106 can be implemented as part of consumer device 100, or alternatively can be implemented on a removable storage device (e.g., optical disk, flash memory, etc.) or on a remote storage device (e.g., a server computer, other consumer device, etc.).

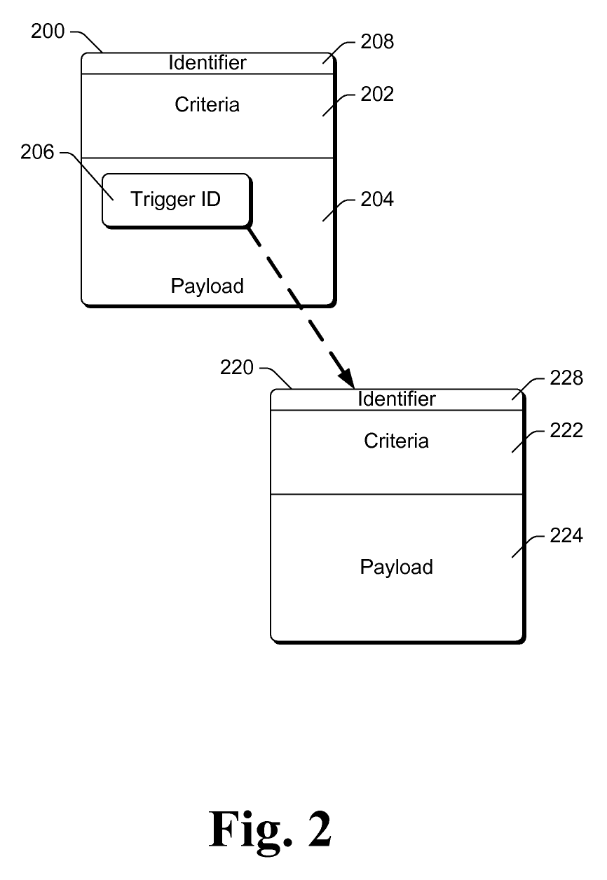

FIG. 2 illustrates example triggers that can be used with the triggers for media content firing other triggers in accordance with one or more embodiments. Trigger 200 includes a criteria portion 202 and a payload portion 204, payload portion 204 including one or more trigger identifiers (IDs) 206. In one or more embodiments, trigger 200 also includes a trigger identifier of itself, shown as identifier 208. In other embodiments no such identifier is included.

Similarly, trigger 220 includes a criteria portion 222 and a payload portion 224. In one or more embodiments, trigger 220 also includes a trigger identifier of itself, shown as identifier 228.

Payload portion 204 identifies one or more actions to be performed when the criteria in portion 202 are satisfied. Indicating that the one or more actions of a trigger are to be performed is also referred to as firing the trigger. A trigger can be fired when the criteria in the criteria portion of the trigger are satisfied, or can be fired by another trigger.

Payload portion 204 includes a trigger identifier 206, which is an identifier of a different trigger (a trigger other than the trigger that includes payload portion 204) that is to be fired when the criteria in criteria portion 202 are satisfied. In the example of FIG. 2, this different trigger is trigger 220. When the criteria in portion 202 are satisfied, monitor module 104 fires trigger 200. In firing trigger 200, monitor module 104 also fires the trigger identified by trigger identifier 206, which is trigger 220. Although only one trigger identifier 206 is shown in FIG. 2, it is to be appreciated that multiple trigger identifiers 206 can be included in payload portion 204. When multiple trigger identifiers 206 are included in payload portion 204, each trigger identified by the multiple trigger identifiers 206 is fired when trigger 200 is fired.

It should be noted that, when the criteria in criteria portion 202 are satisfied, monitor module 104 fires trigger 220 regardless of whether the criteria in criteria portion 222 are satisfied. The criteria in portion 202 being satisfied is sufficient to fire trigger 220 due to trigger 220 being identified in payload portion 204. Additionally, monitor module 104 can fire trigger 220 when the criteria in criteria portion 222 are satisfied. Accordingly, trigger 220 can be fired in multiple situations: when the criteria in criteria portion 202 are satisfied, and when the criteria in criteria portion 222 are satisfied.

In addition to, or alternatively in place of, a trigger identifier such as trigger identifier 206, a variety of other actions can be included in the payload portion of a trigger (e.g., portion 204 or 224). For example, the one or more actions in a payload portion can include displaying advertising content, creating a new trigger, executing an application, retrieving and displaying content from a remote source (e.g., as identified by a Uniform Resource Locator (URL)), and so forth.

Although not shown in FIG. 2, it is to be appreciated that payload portion 224 can also include an identifier of another trigger, analogous to trigger ID 206. For example, payload portion 224 can include one or more identifiers of one or more other triggers (not shown in FIG. 2). Monitor module 104 fires these one or more other triggers whenever trigger 220 is fired. These one or more other triggers are fired when trigger 220 is fired regardless of whether the criteria of these one or more other triggers are satisfied, and regardless of the reason trigger 220 was fired (e.g., whether trigger 220 was fired because trigger 200 was fired, or because the criteria in criteria portion 222 were satisfied). Accordingly, multiple triggers can be chained together, with firing of a first trigger causing a second trigger to be fired, which in turn causes a third trigger to be fired, which in turn causes a fourth trigger to be fired, and so forth.

When multiple triggers are thus chained together, it is to be appreciated that situations can arise where an endless cycle of firing triggers could be created. For example, the criteria of a first trigger may be satisfied causing the first trigger to be fired, and the firing of the first trigger causes a second trigger to be fired. However, the second trigger may identify the first trigger as a trigger to be fired when the second trigger is fired. This can result in an endless cycle of firing the first and second triggers.

In one or more embodiments, such endless cycles are prevented by monitor module 104. These endless cycles can be prevented in a variety of different manners. For example, monitor module 104 may fire each trigger only once, preventing the trigger from being repeatedly fired in an endless cycle. By way of another example, monitor module 104 may restrict how frequently the actions in a trigger are performed, as discussed in more detail below. By way of yet another example, monitor module 104 may search through the current triggers (e.g., those stored in trigger store 106 of FIG. 1) to identify sets of triggers that may result in such endless cycles. A system administrator or developer can be notified of these identified sets of triggers, allowing the administrator or developer to alter one or more of the triggers so that such endless cycles no longer exist.

It should also be noted that situations can arise in which an identified trigger is not present on the device. For example, in a trigger store 106 of FIG. 1, trigger identifier 206 identifies trigger 220, but trigger 220 may not be stored in trigger store 106 yet. In situations where the trigger identified in a fired trigger is not present on the device, no action takes place as a result of identifying the other trigger. For example, the actions in payload portion 224 would not be performed because trigger 220 is not available to device 100 of FIG. 1 yet. However, it should be noted that other actions, if any, in payload portion 204 would be performed when trigger 200 is fired.

Additionally, the one or more actions identified in a payload portion (e.g., portion 204 or 224) can include data, a script or other instructions, or other information to be made available to an application when the criteria in the criteria portion of the trigger (e.g., portion 202 or 222, respectively) is satisfied. This application can be monitor module 104 of FIG. 1, or alternatively another module or application. This application can be an already executing application, or alternatively an application that is executed in response to the criteria in the criteria portion being satisfied.

Various criteria can be included in the criteria portion (e.g., 202 or 222) of a trigger. In one or more embodiments, this criteria includes an identifier of particular media content. This identifier can be, for example, a title or name of the particular media content, a summary or other description of the content, or some other identifier. When such criteria are included in the criteria portion, the one or more actions in the payload portion (e.g., 204 or 224) are performed only when that particular identified media content is being presented.

In one or more other embodiments, the criteria portion (e.g., 202 or 222) includes a time range. This time range can be, for example, a range of seconds, minutes, hours, days, and so forth. During presentation of media content, a current time is maintained and/or accessed. This current time can be, for example, a system or device time maintained by the consumer device present in the media content. When such time range criteria are included in the criteria portion, the one or more actions in the payload portion (e.g., 204 or 224) are performed only when the current time is within the time range identified in the criteria portion.

In one or more other embodiments, the criteria portion (e.g., 202 or 222) includes a channel identifier. This channel identifier can be, for example, a channel number, a call sign or other identifier of a broadcaster associated with the channel, and so forth. When such criteria are included in the criteria portion, the one or more actions in the payload portion (e.g., 204 or 224) are performed only when the media content on that identified channel is being presented and/or that identified channel is tuned to.

Returning to FIG. 1, monitor module 104 monitors media content 108 and/or playback module 102 to identify when the criteria of one or more triggers 112 are satisfied. Monitor module 104 can communicate with playback module 102 to identify the particular media content 110 being output by module 102 at any given time. Alternatively, monitor module 104 can receive media content 108 and monitor this received content directly rather than via playback module 102. Additional information regarding playback of media content 110 can also be obtained from playback module 102, such as an identifier of a program being played back, an identifier of a channel tuned to, and so forth.

In one or more embodiments, monitor module 104 monitors the metadata of media content 108 and/or media content 108 in determining whether and when the criteria of a trigger are satisfied. When monitor module 104 determines that the one or more criteria of a trigger 112 are satisfied, monitor module 104 performs the one or more actions in the payload portion of the trigger (including firing one or more other triggers). In response to performing these one or more actions, monitor module 104 generates a trigger result 114 that is output by consumer device 100. Media content 110 and/or trigger result 114 are output by consumer device 100 as media output 116. Media content 110 and trigger result 114 can be output concurrently as media output 116 or alternatively separately as discussed in more detail below.

Trigger result 114 can be the output of a variety of different types of content, such as video content, image content, audio content, and so forth as discussed above. Trigger result 114 can be presented concurrently with presentation of media content 110. For example, trigger result 114 can be video content or an image that is displayed overlaid on media content 110, such as a small icon at the bottom of a display. These small icons can also be referred to as “bugs”. By way of another example, trigger result 114 can be audio content that is played back concurrently with media content 110. By way of yet another example, trigger result 114 can be video, text, graphic, image, and so forth content that is displayed in a window (such as a picture-in-picture (PIP) window) separate from media content 110. Alternatively, trigger result 114 can be presented separately from the presentation of media content 110. For example, playback of media content 110 can be paused while trigger result 114 is presented.

Additionally, it should be noted that in order to perform the one or more actions identified in the payload portion of a trigger, monitor module 104 may access one or more other devices. For example, monitor module 104 may access a remote device over a network to retrieve content to be displayed as trigger result 114. In one or more embodiments, monitor module 104 accesses a remote server over the Internet to retrieve one or more images or Web pages to be displayed as trigger result 114.

Alternatively, in one or more embodiments monitor module 104 invokes one or more other components or modules to generate the presentation of trigger result 114. For example, monitor module 104 can invoke a Web browser module, a remote device communication module (e.g., supporting RDP (Remote Desktop Protocol)), other applications that display or otherwise present content, and so forth. Such other components or modules can be invoked in a variety of different manners, such as firing an event that is dispatched to the appropriate component or module by an event dispatcher, invoking an application programming interface (API) exposed by the component or module, and so forth.

Monitor module 104 can be implemented to monitor the data of media content 108 and compare it to triggers 112 in a variety of different manners. In one or more embodiments, monitor module 104 (or alternatively another component or module) generates trigger objects and session objects. A trigger object is generated for each trigger 112 and includes the criteria and actions to be performed from the criteria and payload portions of the trigger 112. A session object is also generated that describes the current media content session. The session object includes data of the media content (e.g., channel number via which the media content is being received, call sign of the channel via which the media content is being received, title of the programming that is distributed as the media content, and so forth). Metadata of the media content (or other types of data being monitored by module 104) is typically not included in this session object but rather is analyzed as it is received. Alternatively, this metadata or other type of data can be included in the session object.

Triggers 112 can be provisioned triggers and/or application-based triggers. A provisioned trigger refers to a trigger that is distributed to consumer device 100 by some remote device or component. This distribution is initiated by the remote device or component, and the provisioned triggers typically remain in trigger store 106 until they expire or are updated by the remote device or component. An application-based trigger refers to a trigger that is added to trigger store 106 by an application or module running on consumer device 100. Application-based triggers typically remain in trigger store 106 while the application is running, and are removed from trigger store 106 when the application stops running. Triggers 112 can be embedded in media content 108, or alternatively obtained from other sources.

In one or more embodiments, all of the criteria included in the criteria portion of the trigger need to be satisfied in order for the one or more actions for presenting advertising content to be performed. Alternatively various logical operators, such as “AND” and “OR”, can be used in conjunction with the criteria to allow different combinations to be defined. For example, four different criteria could be listed, at least one of which is to be satisfied in order for the one or more actions for presenting advertising content to be performed. By way of another example, three different criteria could be listed, a particular one of which and either one (or both) of the other two is (are) to be satisfied in order for the one or more actions for presenting advertising content to be performed.

Additionally, it should be noted that criteria can be full-match or partial-match criteria. Full-match criteria indicates that the criteria is to match the data of the programming content exactly, whereas partial-match criteria indicates that the data of the programming is to include at least the partial-match criteria. For example, if the data of the programming were “Microsoft Corporation” and the criteria were “Corporation”, then the criteria would be a partial-match to the data of the programming but not a full-match. Whether criteria is full-match or partial-match can be inherent in the particular criteria, or identified in other manners such as including a flag or other value with the criteria indicating whether it is full-match or partial-match.

Furthermore, partial-match criteria can be a “starts-with” partial-match, an “anywhere” partial-match, or other type of partial-match. A starts-with partial-match indicates that the data of the programming is to start with the criteria, whereas an anywhere partial-match indicates that the criteria can be included anywhere in the data of the programming. For example, if the data of the programming were “Microsoft Corporation” and the criteria were “Corporation”, then the criteria would be an anywhere partial-match to the data of the programming but not a starts-with partial-match. Other types of partial matches can also be defined using regular expressions. For example, quantifiers or wild cards can be used, such as “*” to indicate zero or more characters, “?” to indicate zero or one characters, and so forth. Whether partial-match criteria is starts-with or anywhere criteria, or alternatively other criteria, can be inherent in the particular criteria or can be identified in other manners such as including a flag or other value with the criteria indicating whether it is starts-with or anywhere.

In one or more embodiments, trigger result 114 is presented for a particular amount of time. The duration of the presentation of trigger result 114 can be the same for all triggers, or alternatively vary by trigger. In one or more embodiments, each trigger 112 includes as part of its payload portion an identifier of the duration of the presentation of trigger result 114 for that particular trigger. Alternatively, the duration can be identified in different manners. For example, monitor module 104 can be programmed or otherwise configured with an indication of the duration, media content 108 can identify durations for trigger results occurring during presentation of media content 108, and so forth.

Additionally, in one or more embodiments monitor module 104 performs the actions in a trigger once. After the actions have been performed once, monitor module 104 no longer performs the actions even though the criteria of the trigger may be satisfied. Alternatively, in other embodiments monitor module 104 can perform the actions in a trigger each time the criteria are satisfied. In such embodiments, monitor module 104 can restrict how frequently the actions can be performed. For example, even though the criteria may be satisfied every 30 seconds, monitor module 104 can restrict the actions to being performed no more than once every five minutes.

Such restrictions can be imposed by monitor module 104 in a variety of different manners. In one or more embodiments, a trigger 112 includes an indication of how frequently the actions can be performed. This indication can be included, for example, in the payload portion of the trigger. When the criteria of a trigger are satisfied and the one or more actions performed, monitor module 104 obtains an indication of how frequently the one or more actions can be performed. This indication can indicate a time (e.g., 30 seconds, five minutes, once per day, etc.), in which case monitor module 104 does not perform the one or more actions until after that amount of time has elapsed. Monitor module 104 need not check whether the criteria of that trigger are satisfied until after that indicated frequency is passed. Alternatively, monitor module 104 may check whether the criteria of the trigger are satisfied, but not perform the one or more actions until after that indicated frequency is passed. Alternatively, this indication can be a count value (e.g., 5, 8, 12, 50, etc.), in which case monitor module 104 keeps track of how many times the one or more actions have been performed in response to the criteria being satisfied, and does not perform the one or more actions after the count value has been reached. This count value can optionally be reset at regular or irregular intervals (e.g., hourly, daily, each time a new program begins or a channel change occurs, and so forth).

It should be noted that conflict situations can arise where the criteria of multiple different triggers are satisfied concurrently. Such conflicts can be resolved in a variety of different manners. In one or more embodiments, each trigger includes a priority value and the conflict is resolved by performing the actions for the trigger with the higher priority value. In other embodiments, monitor module 104 can keep track of when the actions for the different triggers have been performed. In such embodiments, these conflicts can be resolved by performing the actions for the trigger that least recently had his actions performed. Alternatively, these conflicts can be resolved in other manners, such as random selection of a trigger, concurrent presentation of multiple triggers, selecting a trigger based on payments received, selecting triggers according to some other criteria or rules, and so forth.

As discussed above, a variety of different criteria can be included in the criteria portion of a trigger. Table I lists example criteria that can be included in the criteria portion of a trigger in accordance with one or more embodiments. It is to be appreciated that Table I lists only example criteria; not all of the criteria in Table I need be used, or alternatively additional criteria can be included.

TABLE I

| Criteria | Description |
|---|---|
| Keyword | One or more keywords to occur in the media content. |
| Title | The title of a program that is included in the media content. |
| Episode | The episode of a program that is included in the media content. |
| Description | A description of a program that is included in the media content. |
| Actor List | One or more actors or actresses that appear in a program that is |
| | included in the media content. |
| Director | One or more directors of a program that is included in the media |
| | content. |
| Currently tuned | A call sign of the channel via which the media content is being |
| channel call sign | received. |
| Currently tuned | A number of the channel via which the media content is being |
| channel number | received. |
| DateTime | A beginning date and/or time for the trigger. This criteria is |
| Beginning | satisfied only if the current date and/or time is after the beginning |
| | date and/or time. |
| DateTime | An ending date and/or time for the trigger. This criteria is |
| Ending | satisfied only if the current date and/or time is before the ending |
| | date and/or time. |
| DateTime Expire | An expiration date and/or time for the trigger. This criteria is |
| | satisfied only if the current data and/or time is before the |
| | expiration date and/or time. The trigger can optionally be |
| | removed (e.g., by monitor module 104) after the expiration date |
| | and/or time. |
| Program-relative | A time value which is added to the program's beginning |
| Beginning Time | DateTime. If no time value is specified, then the program's |
| | beginning DateTime is used. This derived value is then used as |
| | the comparison criteria, comparing against the current DateTime |
| | value. This criteria is satisfied only if the current DateTime is greater |
| | than or equal to the derived value. |
| Program-relative | A time value which is added to the program's beginning |
| Ending Time | DateTime. If no time value is specified, then the program's |
| | ending DateTime is used. This derived value is then used as the |
| | comparison criteria, comparing against the current DateTime |
| | value. This criteria is satisfied only if the current DateTime is less |
| | than or equal to the derived value. |

As indicated above, the payload portion of the trigger can include one or more identifiers of other triggers that are to be fired when the criteria of the trigger are satisfied. In one or more embodiments each trigger is assigned an identifier, allowing other triggers to target that trigger as a trigger to be fired. This identifier can be implemented in a variety of different manners, and in one or more embodiments is implemented as a globally unique identifier (GUID).

The identifier of another trigger can be included in the payload portion of a trigger in a variety of different manners. In one or more embodiments, a fire attribute is included in the payload portion of the trigger, followed by one or more identifiers (e.g., GUIDs) of other triggers that are to be fired when the criteria of the trigger are satisfied. Alternatively, an identifier of another trigger can be included in the payload portion in other manners, such as using different attributes, being stored in a pre-determined location or field, and so forth.

Some example triggers and trigger formats are discussed in the following. It is to be appreciated that these are only examples, and that other formats and triggers can be used with the triggers for media content firing other triggers discussed herein. In the following examples, a fire attribute includes a “triggerid” value representing an identifier of one or more other triggers that are to be fired when the one or more criteria of the trigger including the fire attribute are satisfied. One example trigger is:
[TITLE:xyz], [EVENT:act1], [FIRE:triggerX]
   This example trigger indicates that the criteria is a program title (TITLE) is to be “xyz”. If that criteria is satisfied then an action (EVENT) of “act1” is to be performed. This action “act1” can be any of a variety of different actions as discussed above. In addition to performing “act1”, if that criteria are satisfied then the “FIRE:triggerX” attribute indicates that the trigger identified as “triggerX” is to be fired.

Another example trigger is:
[TITLE:xyz], [CHANNEL:274],[FIRE:triggerX,triggerY]
   This example trigger indicates that the criteria are: a program title (TITLE) is to be “xyz”, and a channel on which the program is played back (CHANNEL) is to be “274”. If the criteria are satisfied, then two triggers are to fired (FIRE): the trigger identified as “triggerX” and the trigger identified as “triggerY”.

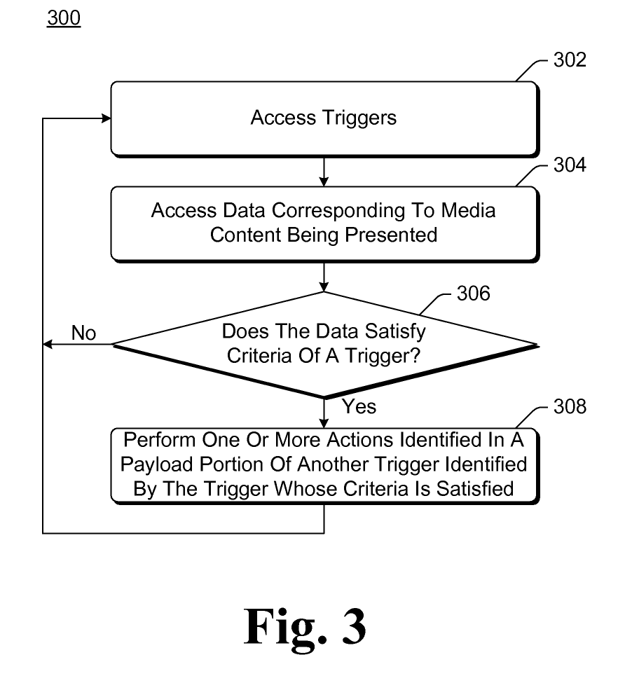

FIG. 3 is a flowchart illustrating an example process 300 for triggers for media content firing other triggers in accordance with one or more embodiments. Process 300 is carried out by a device, such as consumer device 100 of FIG. 1, and can be implemented in software, firmware, hardware, or combinations thereof. Process 300 is an example process for triggers for media content firing other triggers; additional discussions of triggers for media content firing other triggers are included herein with reference to different figures.

In process 300, triggers are accessed (act 302). Each trigger can be accessed in a variety of different manners, such as by retrieving the trigger from a trigger store as discussed above. Additionally, data corresponding to media content is accessed (act 304). This data corresponding to media content can include the media content itself (e.g., metadata, audio data, video data, and so forth) as well as other data describing the media content or its presentation (e.g., an identifier of the media content, a channel via which the media content is received, and so forth).

A check is then made as to whether the data corresponding to the media content satisfies the criteria of one or more of the triggers (act 306). A variety of different criteria can be included in a trigger, as discussed above. This check is repeated until the criteria of one of the triggers is satisfied. When the criteria of one of the triggers is satisfied, one or more actions included in a payload portion of another trigger that is identified by the one trigger are performed (act 308). These one or more actions are thus performed in response to the criteria of the one trigger being satisfied. These one or more actions can include a variety of different actions, as discussed above. Process 300 then continues to access triggers and data corresponding to media, and checking whether the data corresponding to the media content satisfies the criteria of one of the triggers.

The triggers for media content firing other triggers discussed herein allows for various different usage scenarios. By way of example, a first trigger can be embedded in media content, with the first trigger identifying a second trigger to be fired when the criteria of the first trigger are satisfied. The payload portion of the first trigger includes an action to fire the second trigger, so that the actions performed when the first trigger is fired are identified in the payload portion of the second trigger. The media content can be distributed to multiple devices with the first trigger embedded therein, but cause no action to be performed until the second trigger is actually provided to the devices. This allows the first trigger to effectively be “turned on” for a particular device by storing the second trigger on that particular device. This turning on occurs without requiring any changes to the media content or the first trigger embedded in the media content.

By way of another example, the first trigger can be embedded in media content as discussed above, with the first trigger identifying the second trigger to be fired when the criteria of the first trigger are satisfied. The second trigger can be stored on the device, allowing the actions identified in the payload portion of the second trigger to be performed when the criteria in the criteria portion of the first trigger are satisfied during playback of the media content. However, the second trigger can subsequently be removed from the device, in which case the actions identified in the payload portion of the second trigger are no longer performed when the criteria of the first trigger are satisfied. This allows the first trigger to effectively be “turned off” for a particular device by deleting or otherwise preventing access to the second trigger on that particular device. This turning off occurs without requiring any changes to the media content or the first trigger embedded in media content.

By way of yet another example, the first trigger can be embedded in media content as discussed above or otherwise made available to the device. The actions performed by the first trigger can be redirected by changing the second trigger. A first set of actions can initially be included in the payload portion of the second trigger, and then a different second trigger can replace the previous second trigger. After this replacement, the actions in the payload portion of the replacement second trigger are performed rather than the actions in the payload portion of the previous second trigger. Accordingly, the actions performed by the first trigger (as well as any other triggers that identify the second trigger) can be easily changed by simply changing the second trigger. If the first trigger is embedded in the media content, then no changes to the media content or the first trigger need be made in order to change the actions resulting from firing of the first trigger.

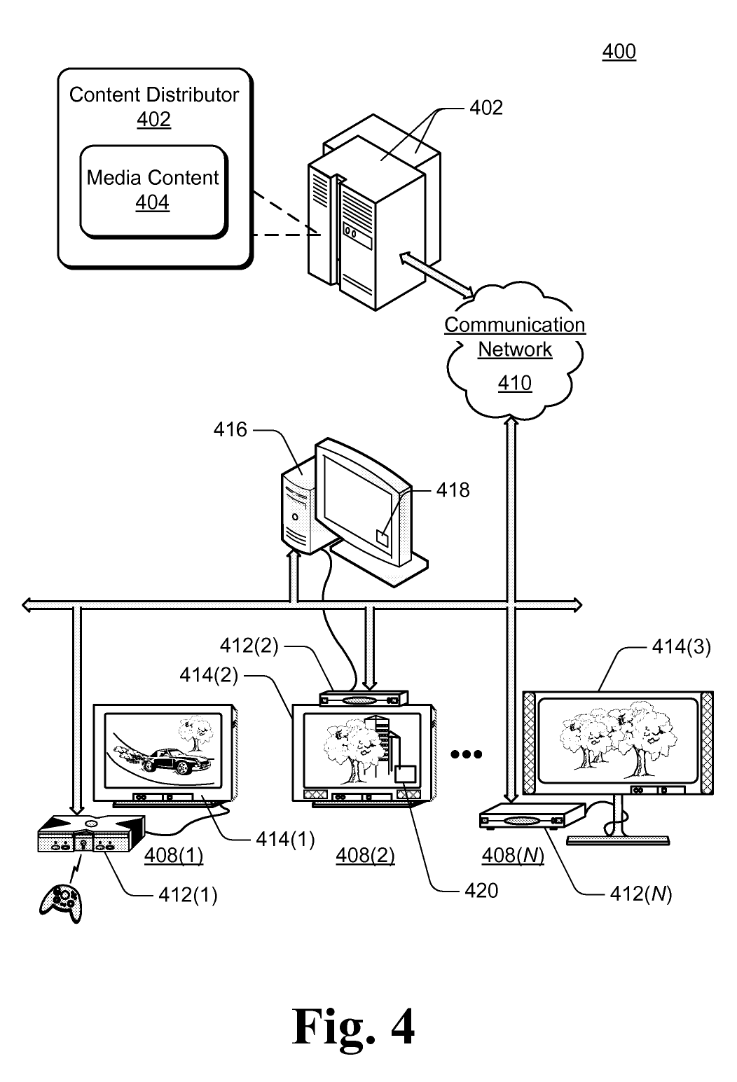

FIG. 4 illustrates an example system 400 in which one or more embodiments of triggers for media content firing other triggers can be implemented. System 400 includes one or more content distributors 402 that communicate media content 404 to any number “N” of various television client systems 408(1-N) via a communication network 410. Client systems 408 can each be, for example, a different type (or alternatively the same types) of consumer device 100 of FIG. 1. Communication network 410 can be implemented to include an IP-based network that facilitates media content distribution and data communication between the content distributor(s) 402 and any number of television client devices.

Each of client systems 408(1-N) includes a respective television client device 412(1-N) and a respective display device 414(1-N), such as any type of television, monitor, LCD, projector, or similar television-based display system that renders audio, video, and/or image data. Any of client devices 412(1-N) can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device. Any of television client devices 412(1-N) may also be associated with a user (e.g., a person) and/or an entity that operates a client device such that a television client device describes logical clients that include users, software, and/or devices.

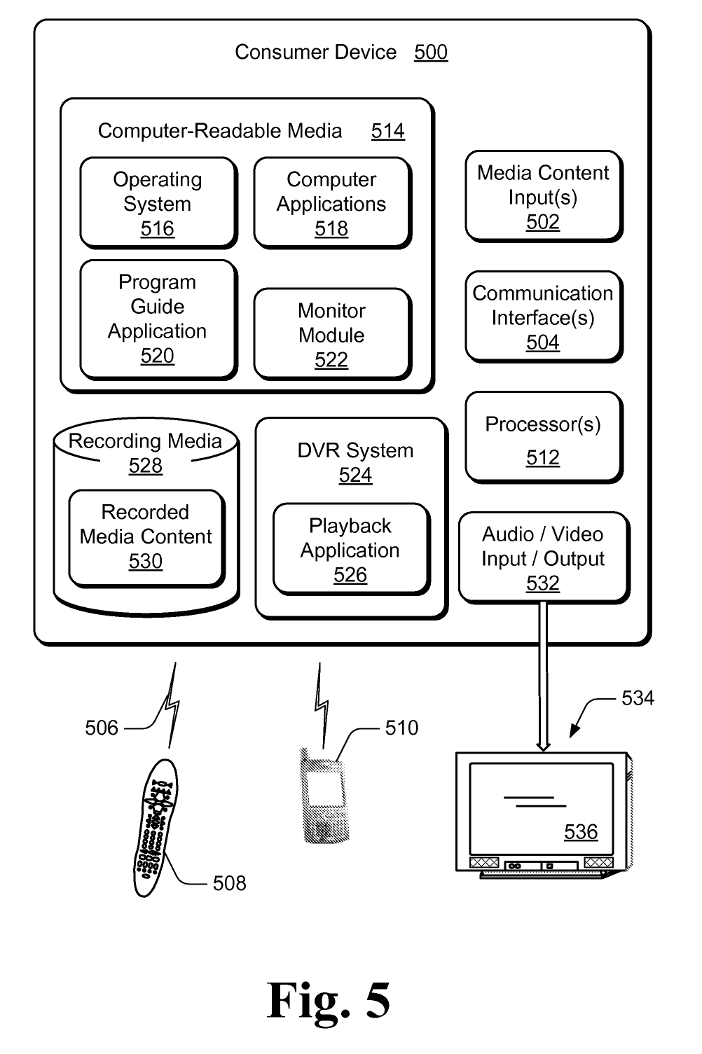

Any of television client devices 412(1-N) of the respective client systems 408(1-N) can be implemented with one or more processors, a communication module, memory components, a media content rendering system, and a monitor module and trigger store to implement embodiments of triggers for media content firing other triggers. Additionally, each of television client devices 412(1-N) can be configured for communication with any number of different content distributors 402 to receive any type of media content 404 via the communication network 410. Further, any of the television client devices 412(1-N) can be implemented with any number and combination of differing components as further described with reference to the example client device shown in FIG. 5.

In this example of FIG. 4, client device 412(2) is a television set-top box that is connected, or otherwise communicatively linked, to a computing device 416 that can be implemented to display trigger results 418. Although example trigger results 418 are illustrated in FIG. 4, it is to be appreciated that trigger results 418 can be presented in other manners as discussed above. Computing device 416 can also be configured for communication with a content distributor 402 to receive the trigger (e.g., triggers 112 of FIG. 1) via the communication network 410.

FIG. 5 illustrates various components of an example consumer device 500 that can be implemented as any form of a computing, electronic, or television client device to implement one or more embodiments of triggers for media content firing other triggers. For example, consumer device 500 can be implemented as consumer device 100 shown in FIG. 1, and/or as any of the client devices 412(1-N) of client systems 408(1-N) shown in FIG. 4. In various embodiments, consumer device 500 can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device.

Consumer device 500 includes one or more media content inputs 502 that may include Internet Protocol (IP) inputs over which streams of media content are received via an IP-based network. Consumer device 500 further includes communication interface(s) 504 that can be implemented as any one or more of a serial and/or parallel interface, a wireless interface, any type of network interface, a modem, and as any other type of communication interface. A wireless interface enables client device 500 to receive control input commands 506 and other information from an input device, such as from remote control device 508, a portable computing-based device (such as a cellular phone) 510, or from another infrared (IR), 802.11, Bluetooth, or similar RF input device.

A network interface provides a connection between consumer device 500 and a communication network by which other electronic and computing devices can communicate data with device 500. Similarly, a serial and/or parallel interface provides for data communication directly between client device 500 and the other electronic or computing devices. A modem facilitates client device 500 communication with other electronic and computing devices via a conventional telephone line, a DSL connection, cable, and/or other type of connection.

Consumer device 500 also includes one or more processors 512 (e.g., any of microprocessors, controllers, and the like) which process various computer-executable instructions to control the operation of device 500, to communicate with other electronic and computing devices, and to implement embodiments of triggers for media content firing other triggers. Consumer device 500 can be implemented with computer-readable media 514, such as one or more memory components, examples of which include random access memory (RAM), nonvolatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 514 provides data storage mechanisms to store various information and/or data such as software applications and any other types of information and data related to operational aspects of consumer device 500. For example, an operating system 516 and/or other computer applications 518 can be maintained as software applications with the computer-readable media 514 and executed on processor(s) 512 to implement embodiments of the triggers for media content firing other triggers.

Consumer device 500 can also include a program guide application 520 that is implemented to process program guide data and generate program guides for display. A program guide enables a viewer to navigate through an onscreen display and locate various media content such as broadcast programs, recorded programs, video on-demand programs and movies, interactive game selections, network-based applications, and other media content of interest to the viewer. Consumer device 500 can also include a monitor module 522 (shown as a software module in this example) to implement various embodiments of triggers for media content firing other triggers as described herein.

Consumer device 500 can also include a DVR system 524 with playback application 526, and recording media 528 to maintain recorded media content 530 that consumer device 500 receives and/or records. Further, consumer device 500 may access or receive additional recorded media content that is maintained with a remote data store (not shown). Consumer device 500 may also receive media content from a video on-demand server, or media content that is maintained at a broadcast center or content distributor that distributes the media content to subscriber sites and client devices. Playback application 526 is a video control application that can be implemented to control the playback of media content, the recorded media content 530, and/or other video on-demand media content, music, and any other audio, video, and/or image media content which can be rendered and/or displayed for viewing. Playback application 526 can be, for example, media content playback module 102 of FIG. 1.

Consumer device 500 also includes an audio and/or video output 532 that provides audio and/or video data to an audio rendering and/or display system 534. Audio rendering and/or display system 534 can include any devices that process, display, and/or otherwise render audio, video, and image data. Video signals and audio signals can be communicated from consumer device 500 to a display device 536 via an RF (radio frequency) link, S-video link, composite video link, component video link, DVI (digital video interface), analog audio connection, or other similar communication link. Alternatively, audio rendering and/or display system 534 can be implemented as integrated components of the example consumer device 500. Consumer device 500 along with the audio rendering and/or display system 534 is an example of a viewing system that can be implemented in a household viewing area for viewing television programs and/or receiving other television media content.

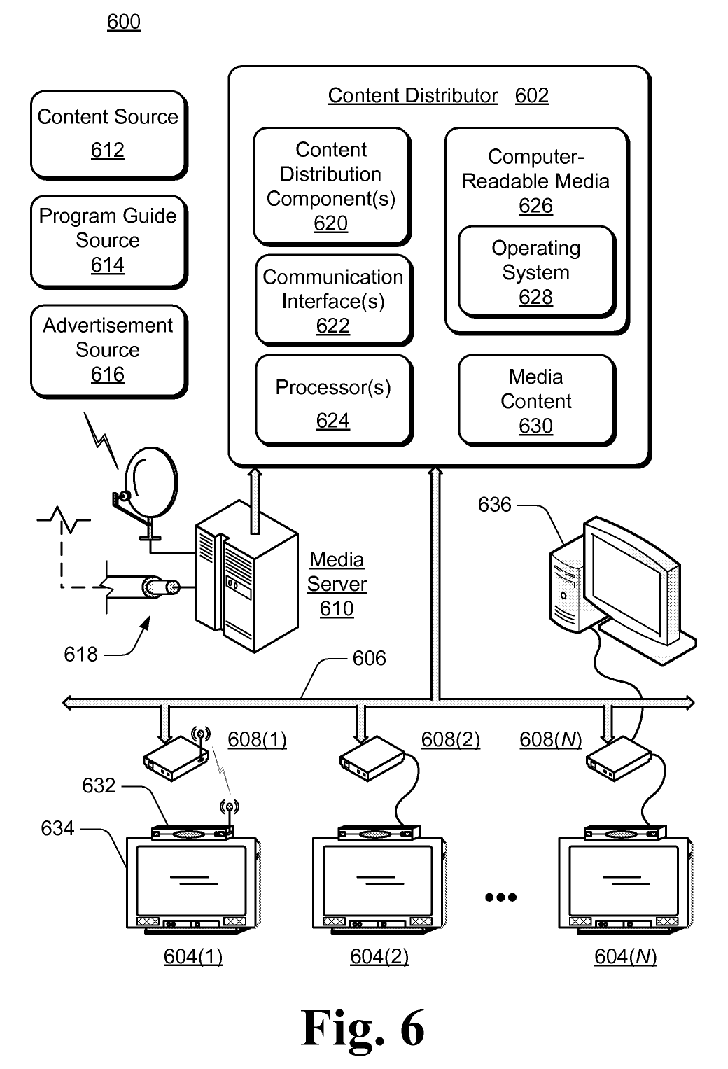

FIG. 6 illustrates an example entertainment and information system 600 in which one or more embodiments of triggers for media content firing other triggers can be implemented. System 600 facilitates the distribution of media content, program guide data, and advertising content to multiple viewers and to multiple viewing systems. System 600 includes a content distributor 602 and any number “N” of client systems 604(1-N) each configured for communication via a communication network 606. Each client system 604(1-N) is an example of the client systems 408(1-N) described with reference to FIG. 4. Each of the client systems 604(1-N) can receive data streams of media content, media content, program guide data, advertising content, closed captioning data, and the like from content server(s) of content distributor 602 via communication network 606.

Communication network 606 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 606 can be implemented using any type of network topology and any network communication protocol, and can be represented or otherwise implemented as a combination of two or more networks. A digital network can include various hardwired and/or wireless links 608(1-N), routers, gateways, and so on to facilitate communication between content distributor 602 and client systems 604(1-N).

System 600 includes a media server 610 that receives media content from a content source 612, program guide data from a program guide source 614, and advertising content from an advertisement source 616. This advertising content can be advertising content associated with triggers as discussed above (e.g., advertising content displayed when the criteria of a trigger is satisfied), and/or different advertising content presented to users of system 600. In one or more embodiments, media server 610 represents an acquisition server that receives the audio and video media content from content source 612, an EPG server that receives the program guide data from program guide source 614, and/or an advertising management server that receives the advertising content from the advertisement source 616.

Content source 612, program guide source 614, and advertisement source 616 control distribution of the media content, the program guide data, and at least some of the advertising content to the media server 610 and/or to other servers. The media content, program guide data, and advertising content can be distributed via various transmission media 618, such as satellite transmission, radio frequency transmission, cable transmission, and/or via any number of other wired or wireless transmission media. In this example, media server 610 is shown as an independent component of system 600 that communicates the media content, program guide data, and advertising content to content distributor 602. In an alternate implementation, media server 610 can be implemented as a component of content distributor 602.

Content distributor 602 is representative of a headend service in a content distribution system, for example, that provides the media content, program guide data, and advertising content to multiple subscribers (e.g., the client systems 604(1-N)). Content distributor 602 can be implemented as a satellite operator, a network television operator, a cable operator, and the like to control distribution of media content, program and advertising content, such as movies, television programs, commercials, music, and other audio, video, and/or image content to client systems 604(1-N).

Content distributor 602 includes various content distribution components 620 to facilitate media content processing and distribution, such as a subscriber manager, a device monitor, and one or more content servers. The subscriber manager manages subscriber data, and the device monitor monitors client systems 604(1-N) (e.g., and the subscribers), and maintains monitored client state information.

Although the various managers, servers, and monitors of content distributor 602 (to include media server 610 in one or more embodiments) are described as distributed, independent components of content distributor 602, any one or more of the managers, servers, and monitors can be implemented together as a multi-functional component of content distributor 602. Additionally, any one or more of the managers, servers, and monitors described with reference to system 600 can implement features and embodiments of triggers for media content firing other triggers.

Content distributor 602 includes communication interface(s) 622 that can be implemented as any type of interface to communicate and receive data from client devices of the television system. Content distributor 602 also includes one or more processors 624 (e.g., any of microprocessors, controllers, and the like) which process various computer-executable instructions to control the operation of content distributor 602. Content distributor 602 can be implemented with computer-readable media 626 which provides data storage to maintain software applications such as an operating system 628 and media content 630 for distribution to the client systems 604(1-N).

Client systems 604(1-N) can each be implemented to include a client device 632 and a display device 634 (e.g., a television, LCD, and the like). A client device 632 of a respective client system 604 can be implemented in any number of embodiments, such as a set-top box, a digital video recorder (DVR) and playback system, an appliance device, a gaming system, and as any other type of client device that may be implemented in an entertainment and information system. In an alternate embodiment, client system 604(N) is implemented with a computing device 636 as well as a client device. The computing device 636 is an example of a connected data store that can record and maintain media content for a client device. Additionally, any client device 632 of a respective client system 604 can implement features and embodiments of triggers for media content firing other triggers as described herein.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer-readable memory devices. The features of the triggers for media content firing other triggers techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
checking, for a first trigger of multiple triggers, whether a presentation of media content satisfies a criteria portion of the first trigger; and
performing, when the presentation satisfies the criteria portion, one or more actions in a payload portion of a second trigger of the multiple triggers.

2. A method as recited in claim 1, further comprising:
checking, for the second trigger, whether the presentation of media content satisfies a criteria portion of the second trigger; and
performing, when the presentation satisfies the criteria portion of the second trigger, the one or more actions in the payload portion of the second trigger.

3. A method as recited in claim 1, the one or more actions in the payload portion of the second trigger including an indication to perform one or more actions in a payload portion of a third trigger of the multiple triggers.

4. A method as recited in claim 1, further comprising:
performing, when the presentation satisfies the criteria portion, one or more actions in a payload portion of the first trigger.

5. A method as recited in claim 1, further comprising:
checking, before performing the one or more actions, whether the second trigger has already been fired; and
performing the one or more actions only if the second trigger has not already been fired.

6. A method as recited in claim 1, the performing comprising:
identifying the second trigger by obtaining a trigger identifier from a payload portion of the first trigger; and
performing the one or more actions only if the second trigger is present in a trigger store.

7. A method as recited in claim 1, the performing comprising:
accessing a fire attribute in a payload portion of the first trigger to obtain a trigger identifier, the trigger identifier identifying the second trigger.

8. A method as recited in claim 7, wherein a value triggerid represents a trigger identifier of the second trigger, the fire attribute having a format of FIRE:triggerid.

9. A method as recited in claim 1, further comprising:
performing, when the presentation satisfies the criteria portion, one or more actions in a payload portion of each of one or more additional triggers of the multiple triggers.

10. One or more computer-readable media having stored thereon multiple instructions that, when executed by one or more processors, cause the one or more processors to:
access a first trigger including both a criteria portion and a payload portion, the criteria portion identifying one or more criteria, and the payload portion identifying a second trigger;
access data corresponding to media content being presented;
check whether the data satisfies the one or more criteria; and
perform one or more actions identified in a payload portion of the second trigger in response to the data satisfying the one or more criteria.

11. One or more computer-readable media as recited in claim 10, the instructions further causing the one or more processors to:
check, for the second trigger, whether the data satisfies one or more criteria in a criteria portion of the second trigger; and
perform, when the data satisfies the one or more criteria in the criteria portion of the second trigger, the one or more actions in the payload portion of the second trigger.

12. One or more computer-readable media as recited in claim 10, the one or more actions identified in the payload portion of the second trigger including an indication to perform one or more actions identified in a payload portion of a third trigger.

13. One or more computer-readable media as recited in claim 10, the instructions further causing the one or more processors to:
check, before performing the one or more actions, whether the second trigger has already been fired; and
perform the one or more actions only if the second trigger has not already been fired.

14. One or more computer-readable media as recited in claim 10, wherein to perform the one or more actions is to access a fire attribute in the payload portion of the first trigger to obtain a trigger identifier, the trigger identifier identifying the second trigger.

15. One or more computer-readable media as recited in claim 10, the instructions further causing the one or more processors to:
perform, when the data satisfies the one or more criteria, one or more actions in a payload portion of each of one or more additional triggers.

16. A device comprising:
a trigger store to store multiple triggers, each of the multiple triggers comprising a criteria portion and a payload portion, the criteria portion identifying one or more criteria and the payload portion identifying one or more other triggers; and
a monitor module, coupled to the trigger store, to monitor data corresponding to media content being presented, to detect when the data satisfies the one or more criteria of one of the multiple triggers, and to perform one or more actions identified in the one or more other triggers identified by the one trigger when the data satisfies the one or more criteria.

17. A device as recited in claim 16, wherein the monitor module is further to:
perform, when the data satisfies the one or more criteria of the one trigger, one or more actions in a payload portion of the one trigger.

18. A device as recited in claim 16, wherein to perform the one or more actions is to:
identify the second trigger by obtaining a trigger identifier from a payload portion of the one trigger; and
perform the one or more actions only if one or more other triggers are present in a trigger store.

19. A device as recited in claim 16, wherein to perform the one or more actions is to:
access a fire attribute in a payload portion of the one trigger to obtain one or more trigger identifiers, each of the one or more trigger identifiers identifying one of the one or more other triggers.

20. A device as recited in claim 16, wherein the monitor module is further to:
perform, when the data satisfies the one or more criteria of the one trigger, one or more actions in a payload portion of each of one or more additional triggers of the multiple triggers.
